(19) United States
(12) Patent Application Publication
(10) Pub. No.: US 2025/0086740 A1
(43) Pub. Date: Mar. 13, 2025

(54) e.Resolv/e.DNA - Resultative Electronic Negotiation

(71) Applicant: David Puckett, Treasure Island, FL (US)

(72) Inventor: David Puckett, Treasure Island, FL (US)

(21) Appl. No.: 18/883,904

(22) Filed: Sep. 12, 2024

Related U.S. Application Data
(60) Provisional application No. 63/582,128, filed on Sep. 12, 2023.

(51) Int. Cl. G06Q 50/18

(52) U.S. Cl. CPC G06Q 50/188

(57) ABSTRACT

Our invention will take this proven negotiation process used world-wide and translate it into an entirely electronic process that is augmented and complimented by leveraging our proprietary algorithms, which leverage both Artificial Intelligence (AI) and Emotional Intelligence (EQ), to remove all human advantages to the process of resolving all types of human conflicts and disputes by allowing the process methodology and technology to negotiate for the parties, without humans, and thus to biases, and individual advantages to the process of using negotiation to resolve disputes and without the need for any human representatives such as professional negotiators or attorneys. See attached process and architecture documentation and the primary algorithm for explanation. This invention includes the option to involve other Human Elements if the “human-less” process hits an impasse and the parties desire advisory services to conclude the negotiation process.

### INTRODUCTION & EXPLANATION

We applied for a Provisional Patent using Thoughts-to-Paper, in 2023 and it was granted by the United States Patent and Trademark Office on Sep. 12, 2023, at 04:23:25 PM ET. The provisional patent is titled: e.Resolv/e.DNA—Resultative Electronic Negotiation, at Utility-Provisional Application, TTP76408.

This document submission is also being made on our behalf by Thoughts to Paper and we are now applying for a Non-Provisional Patent. We are retaining all the content and claims of our Provisional Patent, however, in this Non-Provisional Patent we are adding a few new claims and minor changes to our Patent application architecture. Additionally, there is some deletions, and new process claims due to advances in technology, mostly related to the almost daily development of new capabilities of Artificial Intelligence and capabilities our of primary technology Partner, Alphabet Corporation's Google, and their Google Cloud Platform. We, of course, are not claiming their capabilities are part of our patent claims

### 1. TITLE & REASONING FOR PATENT APPLICATION

### e.Resolv/e.DNA—Resultative Electronic Negotiation

### A Simplified Method of Processes With Outcomes Exceeding Expectations for All Parties

Our objective, for over a decade, has been to build the best-in-class negotiation process methodologies and dispute resolution platforms. With the current improvements in the technologies of Artificial Intelligence (AI), Software-as-a=Service (Saas), and Platform-as-a-Service (PaaS), we now have the computing power to leverage these technological advancements to completely revolutionize the field of emerging technology we call Online Negotiated Dispute Resolution (ONDR). This Patent redefines ONDR beyond any idea, products of services in the market today. This patent application outlines our unique methods and processes that are unlike any other in the marketplace.

e.Resolv/e.DNA is the first invention to blend the best practices of Alternative Dispute Resolution (ADR), Mediation, Facilitation, and Arbitration with Online Dispute Resolution (ODR) and most importantly the best practices of traditional face-to-face Negotiation. However, this invention is mostly focused on reinventing the discipline of negotiation to create a completely disruptive new technological platform and enhanced approach we refer to generically as ONDR.

e.Resolv/e.DNA is a new SaaS and PaaS approach to electronic negotiation that is aided by the latest in AI and, for the first time, is also aided by blending in the leading Emotional Intelligence (EQ) assessment tools. This combination will reduce or remove the emotional aspects of the dispute resulting in an electronic negotiation process and platform with no inherent bias. e.Resolv/e.DNA offers disputing parties a simple to use and equally fair opportunity to resolve all types of conflicts using industry best practices for negotiation baked right into the processes, methods, and platforms.

### What is the Reasoning for This Patent Application?

Welcome to the most innovative and public-spirited method of conflict resolution ever designed to help societies around the world become more collaborative and peaceful than ever possible before. All societies, but particularly that of the U.S.A., believe that their traditional methods of dispute resolution are the best for them, if not in the world. (In the U.S., it is the legal system.) The truth is that societies that do not perform well at this important social function fail and tend towards insurrection and/or revolution.
The system for which we seek a patent is the ultimate distillation of the work of many innovative minds that have been working on various aspects of Alternative Dispute Resolution (ADR) processes for over 50 years. We stand of the shoulders of giants, and this Technology enhanced system of Dispute Resolution (TeDR), combined with our patented invention, is the best synthesis of what they have developed, but somehow failed at producing, one that is attractive, practical, and engaging.
What we offer and need patented is a process of conflict resolution that not only resolves all kinds of conflicts and disputes but educates those who use it to negotiate fairly and effectively. No educational system up to this time in human history does that! People worldwide learn how to debate, that is, to “win” arguments. But they do not learn to listen and negotiate fair results by listening and learning how to resolve problems by understanding their adversaries' own interests. Our system does exactly that and is designed to appeal to ordinary people to use it.
It will be at their fingertips on their smart phones. Every citizen has access to a smartphone and is at least able to have help in accessing the most advanced social science theories and technological marvels available, both now, and in the future to help them get out of the stress of a major conflict in their lives. Legal systems will still exist and be doing what they do, but now all the rest of humanity, who cannot or do not want to access the legal system, will have an easy to use, low-cost alternative that is available to them even in their own home.
The world stands as a precarious crossroads. Now is the time for humans to work together as never before to find equitable and unique solutions from their most annoying personal problems to existential ones for themselves and their society. This system of electronic negotiation/facilitation/mediation is the first to teach humanity that e-negotiation is by far the best way to not only end the fight, but to begin to work together to find a fair and better way to reside amicably.
This is “the better mouse trap” that humans have been seeking for some time. We expect that they will enjoy accessing this system. We need a patent so we can keep this system whole and open to our original development . . . just as Steve Jobs did with Apple.

### 2. REFERENCES

There has been in the last two decades a variety of patents in the industry often referred to as Online Dispute Resolutions (ODR) from companies like CyberSettle Holdings, EBay, Modria, Tyler Technologies, Matterhorn, and others. Additionally, our research uncovered some with references to the terms and including technical references for Electronic Negotiation (EN) including international patents from a company called SmartSettle (ICann Corporation) from Canada. However, we are making claims that our patent and its description below are completely different than any patent we have found in our research for this patent application. There are other references to other patents in the description narratives below.

### 3. INTRODUCTION

Our invention will take this proven negotiation process used world-wide and translate it into an entirely electronic process that is augmented and complimented by leveraging our proprietary algorithms, which leverage both Artificial Intelligence (AI) and Emotional Intelligence (EQ), to remove all human advantages to the process of resolving all types of human conflicts and disputes by allowing the process methodology and technology to negotiate for the parties, without humans, and thus to biases, and individual advantages to the process of using negotiation to resolve disputes and without the need for any human representatives such as professional negotiators or attorneys. See attached process and architecture documentation and the primary algorithm for explanation. This invention includes the option to involve other Human Elements if the “human-less” process hits an impasse and the parties desire advisory services to conclude the negotiation process.

### Keywords: Electronic Negotiation (EN)

Electronic Negotiation Analytics (ENA)
Facilitated Electronic Negotiation (FEN)
Artificial Intelligence (AI)
Emotional Intelligence (EQ)
Justine—AI Driven e.Negotiation Robot (JUST)
Human Elements (HE)
Best Model Settlement (BMS)
Secure Communication Eco-System (SCES),
Intelligent Intake (II)
Quad Negotiation-Centric Databases (QNCD)
Settlement from Inception (SI)

This non-provisional patent is being applied for and to held by David W. Puckett, the founder & principal of Cognitive Resolution Solutions Corporation (CRSC), David W. Puckett is the sole inventor, and he is assigning current and future rights of this Pending Patent to (CRSC). This Patent represents over 40-years' worth of education, experience in dispute resolution and technology industries by the inventor.

Cognitive Resolution Solutions Corporation (CRSC) which has brought other dispute resolution platforms to market since 2014. (originally Rezoud Corporation and ResolvNow Corporation) and lastly the Settle-Now Corporation.

These additional products include Settle-Now.com, ZipSettle.com, OurHomeSettle.com, OurFamilySettle.com and HRSettle.com. Upon the approval and granting of the provisional patent, CRSC plans to introduce in the first quarter of 2025 our newest dispute resolution platform and our first ever Electronic Negotiation Platform. The first two products to hit the marketplace in 2023 and 2024 which were designed to leverage this component, and processes of this patent will be called Avoid-Court.com and Resolve.Site.

This invention is an entirely unique set of process methodologies, algorithms, and technology architectures that together completely revolutionize the process of Facilitated Electronic Negotiation. Focused on the process of resolving all types of human disputes and assisted by Artificial Intelligence and Emotional Intelligence along with negotiation best practices, forms the technology platform we refer to as a Negotiation Engine. Acting equally on behalf of all parties and without any party having a strategic advantage and most importantly without bias that often comes from humans i.e., judges, attorneys, and other human elements.

This invention is influenced by the best practices of the following leading books and methodologies from lead Negotiation Processes:
a. “Start with No,” America Number one Negotiating Coach Explains Why Win-Win is an Ineffective Often Disastrous Strategy, not you can Best it, by Jim Camp. Published, Jul. 15, 2002, ISBN-10:0609608002 ISBN-13 978-0609608005
b. “Getting to Yes, Negotiating Agreement without Giving In, Roger Fisher and William Ury, 1981 (2^{nd} ed. 1991 and 3^{rd} ed. 2011), ISBN: 978-0-395-31757-0
c. “Never Split the Difference, Negotiating as if your Life Depends on it,” by Chris Voss, 2017, ISBN: 9781847941497

The above-mentioned books are proven negotiation steps and processes for human-to-human negotiation and the authors have built businesses around training people to become certified negotiators often helping negotiate on behalf of companies or individuals. While the inventors want to acknowledge they read these books, the principal inventor obtained his master's degree in Conflict Resolution and is focused on negotiation in the process of helping parties negotiate within the context of their conflict.

In the book “Getting to Yes,” the authors identify four principles, one separates the people from the problem, two focus on interests rather than positions, three generates a variety of options before settling on an agreement, and four insists that the agreement be based on objective criteria. Our methodology incorporates some of these core principles, but we believe the objective is beyond just getting to YES, or what is referred to as Win/Win.

Our Emotional Intelligence aspect is a more effective way to separate the parties from the problem. We incorporate a better approach than interests and positions. From the beginning, our processes identify needs and desires confidentially within the system itself (never revealed to the other parties). But the system can see the possible delta and overlap of both parties and the system negotiates for both parties equally around their individual needs and desired outcomes and in a manner that it would be impossible to duplicate in human-to-human negotiation. We feel this is a patentable differentiator in this process.

### 4. FIELD OF INVENTION

In general, this invention seeks to improve and change the Dispute Resolution field. Overall, most disputes today between parties end up with attorneys and as litigation in courts. This invention seeks to simplify how disputes of all types can be resolved without the need for attorneys or litigation.

Based on our experience with previous technologies our company has developed, we believe this invention and the first product we plan to bring to market will simplify and improve access and understanding for all parties. Most people do not have realistic access to dispute resolution systems or services and are often shutout of the legal system because of costs and not understanding how to utilize the legal system. Additionally, this invention will leverage existing best practices of negotiation, mediation, arbitration, facilitation, and even other advisory professions like psychology (counseling) and financial advisory.

### 5. BACKGROUND INFORMATION

The problem is that the legal system in U.S. and everywhere is an adversarial system. The myth is that this trial by ordeal will reveal “the truth” behind the conflict and by doing so, and applying the applicable law, “justice” will be served. Highly trained specialists are needed, and their services do not come free. The judge, as the neutral arbiter, is also not free. The taxpayer pays him to decide who wins and who loses the case.

The USA has, by far, the greatest number of lawyers per capita than any other country in the world. Thanks to America's educational system and the mass media, Americans are led to believe that litigation in courtrooms is the best way to resolve any dispute, large or small. Once the Supreme Court of the United States freed up lawyers to advertise in the 1980s, what some have called a “litigation explosion” occurred and continues to this very day. The courts remain jammed and unresolved conflicts persist and are growing in the United States. Plus, the centuries long public dissatisfaction with lawyers and the courts persists.

The public dissatisfaction with the legal profession and litigation goes back before this explosion and led to the Roscoe Pound Conference in St. Paul, Minnesota in 1976, convened by no less than Warren Burger, the Chief Justice of the SCOTUS. The result was the birth and growth of a new system of “alternative” dispute resolution called Alternative Dispute Resolution or ADR. The main method was something called “mediation.” In other words, lawyers have crowded out the real mediators and replaced them with lawyers as mediators. As the beginning of the 21^{st} century, an invention called the Internet came into being and pretty much transformed every major industry in America and in the world. One industry it did not change much was, no surprise, the legal profession, and the judiciary. They used the Internet to better manage cases, for lawyers to negotiate with one another, etc. Nevertheless, it was not used to empower citizens to resolve conflicts by themselves which is the essence of traditional and classic mediation all around the world. In fact, in some states in the U.S.A., lawyers say they are playing the role of mediator while arbitrating cases and they mandate that only lawyers can do mediations. This has compounded the age-old problem of distrust and failure in the legal system as the premier conflict resolution process in this country.

The essence of mediation is that the mediator is not a lawyer, but is simply a skilled, trained, and empathetic third party to a dispute who helps the parties themselves negotiate a resolution to the conflict that is satisfying to each party. In other words, the mediator is a facilitator of a negotiation process comprised of the parties and the facilitator decides nothing. All the power to resolve the dispute remains in the hands, minds, and hearts of the disputants. This is not an easy job. People in general are not instinctively good negotiators, particularly on their own behalf. This is true in face to face (F2F) situations or even online. Negotiating online has been in existence since the early 2000s. There have been several patents in ODR from companies like Modria (Tyler Technologies) and CyberSettle just to name two, in the Online Dispute Resolution field the past two decades. Our invention and our approach are far different from these previous patents. We would go as far as to say that the limitations in these prior patents were in part the reason that failed. Their technology did not match consumer and market needs. They used technology to augment current processes but did not establish an innovative approach overall as we do in this invention.

### 6. SUMMARY OF INVENTION

Our invention is for a completely new process of Electronic Negotiation which is blended with Emotional Intelligence to give consumers a completely innovative approach for settling all types of conflicts. This invention gives them the opportunity not to have to go to court or retain an attorney in the conventional manner attorneys are typically retained today.

So far, all the attempts at ADR and ODR have had limited success. Particularly, in getting individuals to learn how to negotiate good settlements on their own behalf. This is where this invention comes into play and would become a major disruptor of the chaos that currently engulfs the field of conflict resolution in general, but particularly in the legal system. Think of it like Uber has been to the traditional taxi business and Airbnb has been to the hospitality industry. In each case, the traditional system has been improved by putting the service into the hands of the consumer. This is what this invention will do for and with the legal industry. The legal industry cannot do for the American people what this invention will do for them. Yet, the legal industry will not lose any business since the people using this technology were not really using the traditional legal system anyway.

This invention is a technologically enhanced system of dispute resolution that is almost exclusively done online. The parties are taught, via the algorithm, how to negotiate on their own behalf. But if they fail to negotiate a mutually satisfying result online in the system, they can ask for help from a trained facilitator provided by the system. The facilitator will also have online tools to help the parties recognize how to best find solutions to their dispute.

As pointed out above, since the founding of this county, the legal system that was instilled in this country came primarily from or was influenced or modeled after what was used at the time in England. Our forefathers and legal scholars have attempted to evolve and refine the legal system in the United States over the last 250 years, but today in the USA the legal system has gotten too expensive and complicated for the average citizen to participate in without a lawyer and leveraging the court. Yet, a significant percentage of disputes and dispute types could easily be resolved without an attorney or the requirement to even go to court.

The Internet and technology in general have virtually changed every major industry in our economy. Example, the Real Estate Industry was one of the first professional industries that leveraged the Internet commercially and there were concerns initially the technology was going to replace the Real Estate agent and broker. It has been nearly 30 years since Real Estate listings were moved to web based and cloud base systems. Today there are still as many agents and brokers, but the internet has made it easier and less expensive to find homes, make offers and close transactions via the web. Every industry has been changed by the Internet; however, the Legal System has been one of the least change industries and primarily due to the threat or perceived threat of Unauthorized Practice of Law (UPL). The Covid-19 Pandemic caused the legal industry to change. When the courts were closed the Legal Industry went to video conferencing technology like Zoom for hearings, depositions, trials, mediations, and arbitrations.

Since the early 2000's and partly due to video conferencing, the term Online Dispute Resolution (ODR) was introduced and, soon to follow, technology platforms for Dispute Resolution started showing up in the marketplace from a variety of vendors (most of who are no longer in the marketplace). All technology adoption follows a Technology Adoption Life Cycle curve (see image below). All technologies of all types follow this model for gaining market acceptance. The initial phase, when emerging technology is first introduced, is called the Innovation Phase and it typically lasts one to three years and then moves into the Early Adopter Phase. The combination of these two phases is often referred to as “Early to Market.” This is when technology companies, often startups, bring New Emerging Technology to market. They then try to get customers to evaluate the new technology. These projects are referred to as Proof of Concept or Pilot Projects. The companies that introduce these new technologies suffer financially getting their modern technology to gain acceptance and it is not unusual for most companies to fail. But the companies who do survive, and make it to Early Majority Phase, either become highly successful companies in this emerging space or they are acquired by large existing technology companies. This is a particularly important point for this patent application to explain what has happened in the dispute resolution space and why the Innovation Phase of what is commonly referred to as Online Dispute Resolution (ODR) has lasted nearly 20 years. It was not slowed or prolonged due to technological aspects. ODR has been slowed because the legal market space lacks standards, has disparate legacy technology in the court systems, and overall is not a fan of changing and having technology and non-attorneys at the center of the industry. The industry, due to no perceived need for this type of technology, caused the acceptance period to be vastly longer than normal.

### FIG. 1: Technology Adoption Curve

“Crossing the chasm” is a term used to describe the transition from early adopters to the mainstream market in technology adoption. It is a crucial phase for businesses that can lead to market success. The chasm is the gap between early adopters and the early majority in the technology adoption lifecycle. We feel THE CHASM is now and this market will emerge in early 2025!

Similarly, in the last 50 years Alternative Dispute Resolution (ADR), which is not technology, is a process of using methodologies for mediation and arbitration (primarily) to help consumers resolve dispute without the need for litigation and traditional legal processes. In the 1970's and 1980's the ADR practices of mediation and arbitration started gaining popularity and there were community-based movements to use mediation especially as an ALTERNATIVE to the legal system.

The more successful and widespread the movement became the more the legal industry tried to stop it. They claimed practitioners and companies providing ADR services were providing legal advice and thus were threatened with UPL action, which is a felony crime in most States. The basic claim was that all claims have a legal basis and, therefore, the parties to the dispute each needed an attorney. Most cases file a lawsuit and then once in the court systems, the Judge or magistrate could order or recommend mediation to the parties. This enabled the existing legal system to hijack the independent or alternative to the courts approach of ADR. Most mediations in the courts follow or come about because of a lawsuit and the court orders the mediation. The alternative or non-legal system approach died. For this same reason, ODR, until Covid-19, was marred by the same obstacles of acceptance.

The legal system has not used the best practices of the Alternative Dispute Resolution industry. ADR is not just mediation and arbitration. It also includes facilitation and the discipline of negotiation. There are over 100 Universities in the USA that offer Master Certificates, Master's Degrees, or PhDs in Conflict Resolution or Peace Studies. These students do not study law. These academic programs are a multidisciplinary approach to all aspects of dispute resolution and until the last couple of years centered around process methodologies, best practices, and human factors. Since industry was built, like the courts, around having humans at the center as trained neutrals there has not until recently been much consideration around a technology platform replacing or augmenting the human aspects of dispute resolution.

However, mediators are not trained in negotiation. Here is a quote from an article titled “Why Traditional Mediation Methods Do Not Work,”
Traditional mediation today is often led by mediators who are not formally trained in the art of negotiation. As a result, their version of “mediating” is simply “splitting the pie,” often leaving both parties dissatisfied. These mediators choose to mediate upon the belief that all available answers appear to lie along a straight line between the parties' respective positions. Often the only “creative thinking” they exhibit is to suggest splitting the difference.”
(See Hyperlink 1 to read full article)

In a 2020 report, (See Hyperlink 2), the report concludes more law schools fail to prepare their students, eventual attorneys, to work with clients and especially do not teach negotiation in their programs. This is a quote from the article,
One thing that I noticed that a few young lawyer's struggle with, which is helping a client get to yes. Which is not, “well the law says this, so no, you can't do that.” [Instead, we need new lawyers to say] “The law says this. So, if you want to accomplish your business goal, you will need to do these things.” . . . Clients are not looking for us to tell them what they cannot do. They are looking for us to help them understand how to accomplish their business objectives.

Negotiation is the core activity or function of dispute resolution in general. Law schools do not teach negotiation, and attorneys are not prepared to lead the negotiation process for their respective clients. The central premise of our invention is that attorneys and the legal system, as it is today, are not the best resource or environment for settling conflicts. And, in fact, some would argue the economic models of retainer fees and contingency fee representation is not conducive for simple and inexpensive resolutions.

In conclusion, our goal is to offer a unique technology platform that utilizes new methods and processes complimented by the almost daily emerging technology and power of Artificial Intelligence and Emotional Intelligence to deliver a technology platform that is designed to leverage the best in the industry Electronic Negotiation where we expect about 85-90 percent of disputes of all types to be resolved without the need for human intervention. However, the Human Element and other resources are always just a click away for professional advisory if required as the result of an impasse. Additionally, even though video conferencing has been available from a variety of technology vendors like Microsoft, Google, Apple, Zoom, Citrix, just to name a few, our platform is going to offer video conferencing as required in a fully automated fashion with our propriety Secure Communication Echo System (see technical diagrams below). The video conferencing will be designed to truly offer and emulate the best practices of ADR and is easy to use for all parties. Thus, our platform will be unlike anything in the marketplace to date.

### 7. DRAWINGS

Below are our flowchart drawings for our patent, showing our processes and the underlying technology components, presented in Four (4) separate detailed drawings. (See below, three (3) in a row flow charts of my invention, and the fourth and final diagram is a complete representation of our invention, including the process at the center and our market feeds and technology partners.

FIG. 2: This flowchart shows how the Communicator state machine communicates with e. Resolv to collect information from the users and begin to make decisions & User and System Interface points.

FIG. 3: This flowchart shows how the system is now in an iterative process of evolving the dispute toward a final solution resulting in a set of settlement documents.

FIG. 4: This flowchart shows how the system is now in an iterative process of evolving the dispute toward final solution resulting in a set of settlement documents.

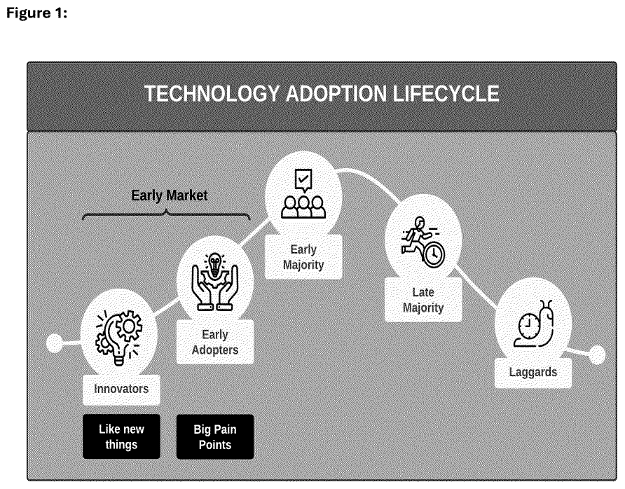

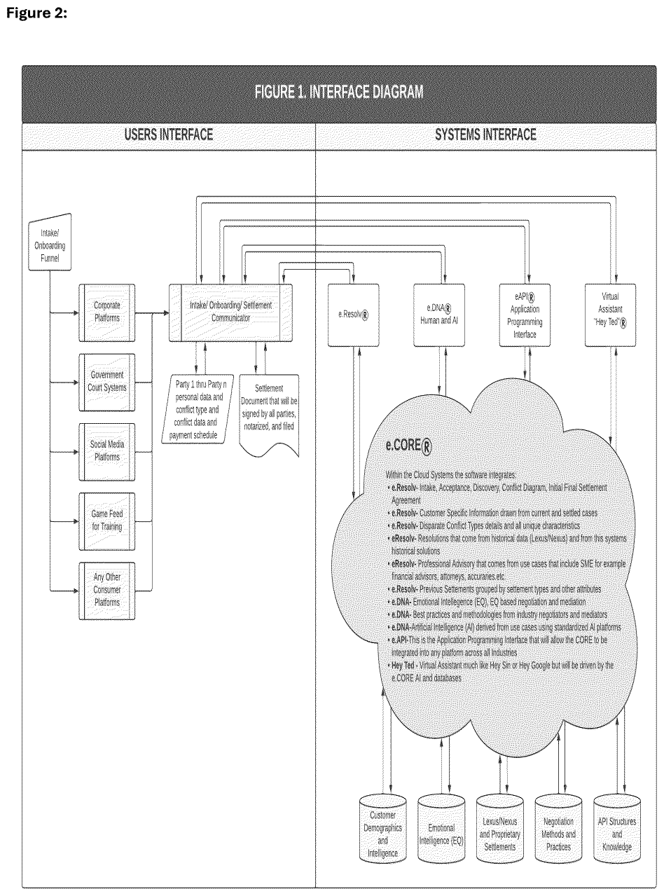

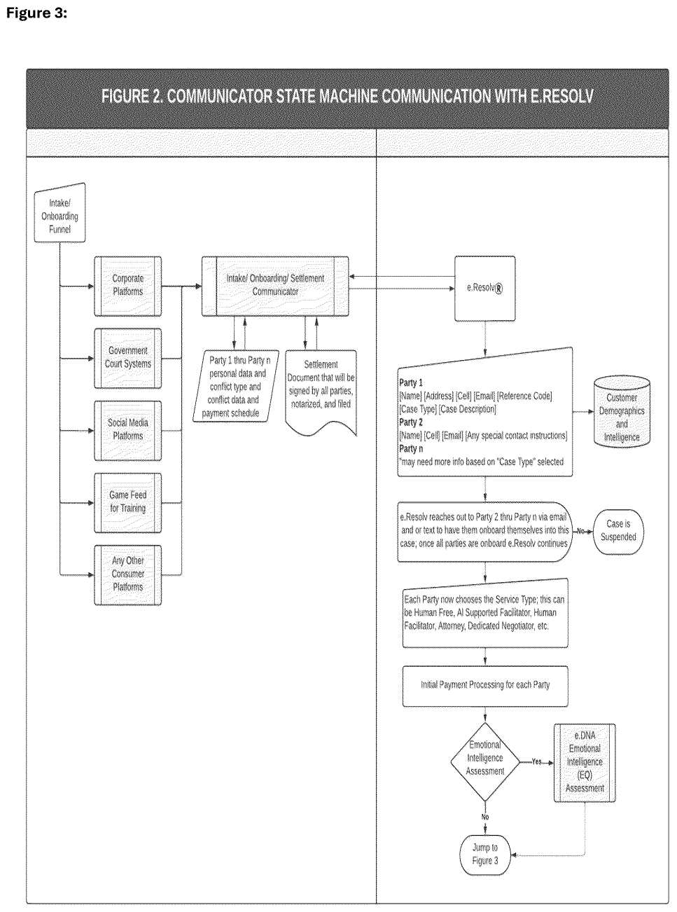

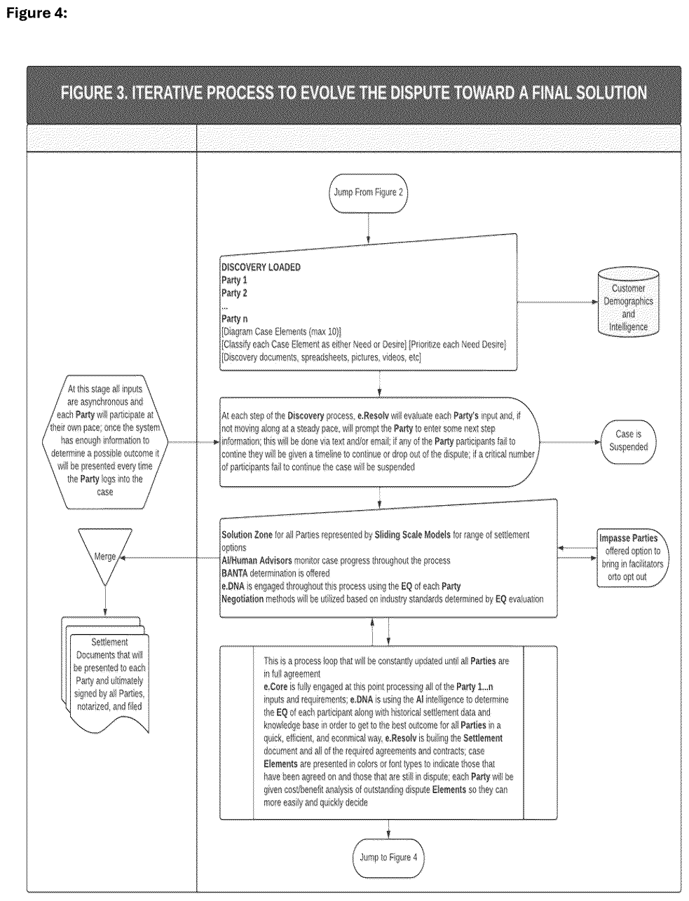

(See Charts and Images Document)

### 8. DETAILED DESCRIPTION OF INVENTION

e.Resolv/e.DNA is a completely disruptive new methodology and technology platform and is the next generation of our Technology-enhanced Dispute Resolution (TeDR) model. This new process methodology blends multiple disciplines which, based on our knowledge and research, have never been combined or been available via a single technology platform. This invention is for people with all types of disputes to leverage for resolving their disputes. We are combining the disciplines of Emotional Intelligence (EQ) and Electronic Negotiation (EN) in a unique process that allow emotions to be neutralized and to leverage a completely new process free of bias via the technology-based negotiation which relies on Artificial Intelligence. And, we have incorporated negotiation best practices into a unique methodology. This new methodology is an equal blend of incorporating an emotional assessment to identify the emotional makeup of the parties via a specialized questionnaire that was designed uniquely for our new methodology. The parties in conflict take this specially designed questionnaire and the results are analyzed, and a computer-generated report is then provided to each party explaining how they process emotions related to this conflict. The primary objective is to help the parties defuse the emotional aspects of the conflict, so they understand their own emotions.

Additionally, the AI uses the results from each party, related to their emotional make up, and all interactions, including systems based and human based interaction will consider each party's emotional mark up, and even system-based interaction and voice intonation will be considered both marginalizes or remove the Emotional Elements of the conflict.

It is estimated the as much as 90% of conflict is based upon emotions. In general, there are 4 general emotional constructs in conflict: Hostility (self-focused: Self-Conscious (self-focused avoid) Relational Positivity (other-focus approach) and Fear (other-focused avoid). Our methodology and AI driven technology process marginalizes and removes the emotional aspects of conflict.

Second, we have leveraged the best practices of Negotiation from at least four leading books on negotiation and we have designed a complete innovative and unique methodology and built software to allow the SYSTEM ITSELF to negotiate for the parties and the system is thus a NEUTRAL providing a non-biased platform for both parties and thus neither party has any advantage. Electronic Negotiation replaces the human elements of traditional human based negotiation and gives the parties a NEUTRAL platform so that it's negotiating equally and using the same methodology for all parties (thus no distinct advantage) and thus since the platform is build using Negotiation Industry Best Practices, with no human bias or advantage it fair and provides the fairest platform to obtain the desired outcome for both parties. We believe our technology and methodology allows both parties in a conflict to achieve a better desired outcome than would like to be achieved using human negotiators or negotiating themselves.

### 9. EXAMPLES OF HOW THE INVENTION IS USED

This invention can be used to assist Dispute Parties to resolve almost any type of dispute, simply, without a need for attorneys, courts or in many cases very limited Human Involvement. As stated above, we are expecting 75 to 90 percent of conflicts to be resolved without the need for any human beyond the system assigned Case Manager. As noted above and below, Human Advisory capabilities are always one-click away from engagement as an advisor to help if the parties reach an impasse where they cannot agree on some final matters. Again, the processes and platform are designed as an ALTERNATIVE to the courts, where the parties can use AvoidCourt.com to attempt to resolve without the need for attorneys or litigation via the court, but upon impasse they can easily engage professionals like attorneys, negotiation advisors, psychologists and other professionals to assist them if required.

Our unique intake begins the parties inputting the nature and component of the dispute and being offered immediately the opportunity to play our Dispute Simulation Game and upon mutual acceptance to attempt to utilize our platform they can begin loading their case details and discovery documents and we are offering 15-minutes or no cost time to resolve the dispute. We expect we will be able to resolve most disputes without human involvement and the systems built in negotiation capabilities make our Patented Process a completely new way to resolve all types of conflicts.

### 10. DETAILED DESCRIPTION OF THE INVENTION

Here is a summary of our unique factors of the invention and detailed with this patent application that we feel makes our request for this patent one-of-a-Kind and reinvents conflict resolution beyond any existing processes or systems that have ever been introduced.
a. Facilitated Electronic Negotiation, the unique part of our invention is this document and our claims below, describe an entirely new PROCESS for resolving all conflicts. In the US, the legal industry wants and benefits from a US Population conditioned to believe that if a conflict arises, and especially if there are laws or any possible legal aspects involved, resolution will require an attorney to navigate and leverage the legal system. We are seeking to disrupt this traditional model of conflict resolution claimed by the legal industry. Mediation and Arbitration was positioned initially as ALTERNATIVE Dispute Resolution (key word, Alternative) and the two methodologies for delivering conflict resolution by Mediation and Arbitration was intended to be an alternative for citizens and potentially not have to use the legal system. However, about two decades ago basically both Mediation and Arbitration professions were assumed by and today, mostly controlled by the legal industry and steps into the legal industry litigation process. For decades, the legal industry has used the threat of Unauthorized Practice of Law (UPL) to keep non-lawyers or non-law firms from delivering conflict resolution services and any individual or company who did was instantly slapped with an UPL cease and deist claim. My invention, as its primary objective, is to reengineer the entire process of conflict resolution and completely distance our services from those delivered by the US legal industry including Mediation or Arbitration. In the heart of all forms of conflict are three components: 1. Emotions (referred herein, as EQ)—90% of conflict is emotions and this is a core of our proprietary algorithm contained within this application 2. Elements of Law (if applicable) where law is violated and understanding their relationship to the conflicts 3. Best, Desired or Required Process to resolve the Conflict—our methodology and technology platform to deliver, a facilitated human enhanced process to fully leverage our e.Resolv and e.DNA based Dispute Resolution Engine/Platform. All elements in the remaining claims provide supporting claims to this overall concept. Human Negotiation has been around since the beginning of time. There are professional negotiators and many methodologies and best practices for Negotiation. However, AI can now assist and enhance the process of any type of negotiation and our invention is a unique blend of technology, processes and human elements.
b. Intake System, aided by a planned social media campaign, the intake will be targeted to draw attention to our unique process for Dispute Resolution and Electronic Negotiation, and our intake process will be a complimented by a Computer Game, targeted at Gen-X and Millennials most familiar with computer gaming, thus our simulation game will introduce potential clients (disputants) via the game on how to use the technology and how simple and fair this our new process it. Also, we are going to offer 15 minutes FREE to all clients so that they can attempt to resolve or at least get the process started with the goal of convincing them of the simplicity and uniqueness of the platform for resolving all disputes. Our unique intake is the first step in the process of our propriety electronic negotiation process. The intake form is on the homepage, and it initially allows one party to the conflict to enter key elements of the conflict to start with the Parties Name, Contact, Type of Conflict and depending on the Type, there are subroutine questions. After capturing this initial intake questions, the next important step is having our intake system automatically call the other party or parties to the conflict, initially via email, then backed up by a manual step of our case managers following up with the other party to determine interest and agreement to participate and answer questions. This is VERY IMPORTANT—our intake is how we expect to differentiate ourselves from any competitor, but also to help all parties in conflict have a better way to resolve conflict. We will then grow the reputation of our technology services, capture a larger market share. As a good non-technical reference to explain this proprietary claim, the Orlando Law Firm, Morgan and Morgan, used traditional advertising to grow themselves into the largest personal injury firm (primarily) in the United States the last 25+ years. The have revolutionized the Personal Injury Legal Services business be using traditional advertising to feed their web-based intake system and most know the blend of this intake along with spending hundreds of millions of dollars in marketing and advertising contributed to their massive success. Our proprietary intake will not model theirs as ours will be interactive, AI controlled and assisted by our case managers as the human element of gaining market acceptance for the CONSUMER MARKET. We are NOT trying to piggyback on the courts or legal industry. Our primary goal is to grow like Uber and Airbnb via our Applet, complimented by limited social media soft ads, and grow primarily on word of mouth due to our unique intake and effective way to resolve conflicts without the traditional complaints of the legal system—hard to navigate, frustrating, costly, and timing consuming.
c. Multi-Database Design & Architecture, as displayed in the final diagram our invention uses four (4) primary databases, that allows AI to in almost an instant query across these four database repositories to actively allow the two parties to electronically negotiate real time online, while being able to have the necessary elements, including the emotions, factored into a facilitated electronic negotiation. This will yield optimal results and satisfaction of each party with both the process expediency and cost effectiveness. The four databases are: 1. Customer 2. Conflicts 3. Resolutions 4. Advisory. The platform and system increase its overall efficiency as all for database sizes grow. The real value is at the dataset of resolved cases, including the type of case, elements of matched similar conflicts and settlements (sought and agreed). Thus, as the repository of settled cases is fed into our databases the more future cases are satisfactorily resolved. However, even on launch, the Conflicts, Resolutions and Advisory Databased will be populated initially with case and resolve data acquired from by data from West Law Nexus. The dataset will be especially selected and populated before launch so parties with any type or size of dispute and the conflict resolving services we deliver, will be enhanced by the initial data population and combined with our proprietary algorithms in a way unlike anything available today.
d. e.Negotiation Conflict Resolution Game, when we launch the 1st commercial product built on this methodology for the Patent Application, it will include a Computer Simulation Game that can be used by disputants to learn how this technology can benefit them and the other parties to resolve their conflict negotiating with our technology vs humans (attorneys, ADR professionals or the courts). The game will also be used like a traditional computer game with a built-in scoring mechanism and twice a year we will acknowledge the top scorer and there will be prizes awarded. We expect this game component to drive adoption and understanding of our new revolutionary technology platform.
e. Justine our AI Robot, we have developed an AI robot assistant to help our customers initially learn how to use this technology to resolve all conflicts in our user computer game. Justine will represent the entire capability of our technology platform and she will always be a click and way for customer support both technical and advisory as it relates to conflict resolution and e.Negotiation capabilities overall. We feel Justine will be instrumental in market acceptance of our technology. Justine is AI Driven, and we expect her to become a consumer desired entity like (Suri, Okay Google or Alexa) for interaction with our platform. Justine will always be a point or mechanism to determine and recommend when human elements might be needed. Lastly, our case managers will be updated by Justine on activities related to the case and the human element can monitor and determine how they might be able to assist. Justine is a vital element in delivering the best possible customer service.
f. Secure Communication Eco-System (SCES), we do not allow any outbound or inbound email or messages) all communication remains internal and secure. We will launch secession for video conferencing and all communications between parties within our private cloud (not public web) and that system includes an end of case purge processes to ensure all private and personal information is not maintained by the system upon case settlement or termination of service. We do, however, take non-confidential information about the case and how it was settled to populate our internal multiple databases, so that our AI becomes smarter and more functionally valuable on each settlement to better serve our clients. Some of our competitors have had data security breaches and continue to have extreme liability related to secure communication of their various solutions. Our SCES is proprietary and designed to protect all communications while resolving a case and then packaging the confidential data to return to the proper party or parties upon resolution. We will purge the confidential data upon settlement and otherwise retain the conflict style, conflict elements, solution suggestions and how the case was ultimately settled, as well as the elements of the settlement.
g. Best Model Settlement (BMS), internally we refer to it non-technically as Best Match or Similar Conflict. This claim is the heart of our invention. Also, two (2) of the four (4) unique databases (described in letter C above) the Conflicts and Resolution databases will be linked as part of our proprietary electronic facilitated negotiation process. We are looking to “suggest” a like settlement as a match as similar as possible to the style of conflict between the parties who elected to use our dispute resolution platform from settled similar conflicts. This BMS feature is unique as it is then embedded into our overall algorithms to actively make even simple suggestions based on data from the selected similar cases but additionally our (HE) Case Managers are involved in the validation of the similar cases. The Case Manager can also override or compliment the BMS process with their own suggestions from their experience and knowledge in a unique neutral manner.
h. Best Practices in Conflict Resolution, we have an Academic Think-Tank Non-Profit (501.3.c) named the ResolvCommunity Corporation (RCC) is dedicated to leveraging a multi-disciplinary graduate students of the following academic disciplines: Law, Business (MBA Students), Information Technology, Psychology (focused on EQ) and Conflict Resolution. It should be noted, since our corporate inception, back in 2013 (Rezoud Corporation) today, Cognitive Resolution Solutions Corporation (CRSC) we have leveraged over 50 graduate students on a variety of research projects. In fact, our Technology-enhanced Dispute Resolution (TeDR) methodology has been annually enhanced and improved by these various research projects by graduate students and me or the management team of CRSC. We are hereby making this claim that by partnering with our affiliated Non-Profit makes us and this invention unique and, in the future, these multi-disciplinary students will continue to research Conflict, Legal, Psychology, Conflict Resolution and IT to publish in the public domain Industry Best Practices and the Ethical Utilization of Artificial Intelligence in Conflict Resolution, Emotional Intelligence and the Law. This is vital for our invention's acceptance by all consumers. The Legal Industry in part is trying to create fear that AI is not ethical or trustworthy. This this Non-Profit and our next and future generation versions of our public domain public TeDR Methodology document will be vital to us and our product and service acceptance and in fact help the industry. The traditional Online Dispute Resolution Industry lacks both technology and process standard and thus is not gaining widespread acceptance by either the Legal Industry or consumers. Displayed in the diagrams above, the system will include and incorporate Block-Chain technology to blend our technology with integration primarily with case history data via Westlaw/Lexus & our other internal data which will grow daily based on system use. The EQ-I 2.0 Emotional Intelligence assessments results, then fed both into other licensed software components and blended with our algorithm that measures and monitor emotions and track during all interactions with our system.
i. Automated Conflict Diagram, our custom designed process of questions for uncovering the key elements of each conflict but also identifying the secondary elements that are likely contributing to this conflict and power by AI. We track the top 10 elements and the diagramming activity of the process then the system allows the elements of conflict (minus emotional aspects) to be diagramed for the disputing parties so that they can visually see the elements of the conflicts and the task at hand to resolve it. There is an acceptance required of the Conflict Diagram by all parties before advancing to the next step. This is a unique AI driven process which allows the diagram to be viewable and updated interactively as elements of the electronic negotiation change.
j. Settlement Statement Presentation, from the beginning of the process (following Discovery loading and Conflict Diagram), our approach offers the framework and objectives of the Final Settlement Agreement immediately after the parties agree to leverage the system. The Settlement statement is always one-click away and this unique feature keeps the disputing parties focused on settlement. Throughout the process the Statement Agreements are visible to all parties. The elements of agreement are in “GREEN” and the elements unresolved remain in “RED.” This is an active process as the parties go back and forth in negotiations fed by our algorithms blending AI and EQ while also running the ongoing active negotiation activities. Our user test case results have shown that the Settlement Statement being generated (almost ready to sign) in GREEN (what they have agreed to) and RED, displaying what they still need to focus on to reach settlement is one of the unique features of this invention.
k. Utilization of Emotional Intelligence (EQ), the parties are instructed to take a specially designed subset of questions from a market leading Emotional Intelligence Assessment. Personally, realizing 90+% of conflict is Emotional and the legal system, no anything available today measures or leverages the parties Emotional Intelligence or even other tools to monitor and consider the emotional aspects of conflicts. This invention is unique in this area. We give the dispute parties the option with strong encouragement to the EQ-1 2.0 Emotional Intelligence Assessment (which is the most internationally recognized Emotional Intelligence Assessments). A great analogy of comparations is the Myers-Briggs Personality Test™, this test has been leveraged by corporations in hiring and staffing decisions for hiring prospective employees. This test is considered by most of the Psychology Industry as a very valid

Personality Measure Tool and thus Employers have used it to match prospective employees with both the overall culture of the company and even the executives managing prospect employees. Much in the same we, this invention leverages the EQ-1 2.0 Assessment to analyze the emotional makeup of the disputing parties. After completing the optional assessment, the results are presented electronically including an explanation of the party's emotional makeup and approach to dealing with conflict. The results are confidential and only viewable by the individual party, the Case Manager and engaged Professionals to better understand the emotional makeup of the parties. The overall purpose is to DEFUSE the emotional aspects of the conflict. The primary tool is the commercial 3rd party Emotional Intelligence Assessment, but my invention will also use additional technology entering the market. The determined emotional state which could vary during the process of attempting to resolve this conflict is constantly monitored. What makes this invention unique is our proprietary algorithm (formula contained within this document) and the fact we are using electronic negotiation vs the traditional process and experience the parties would have in litigation, mediation or arbitration. Lastly, and most importantly the result of the assessment allows the AI to recommend settlement options using language that is complimentary to individual's emotional status for the best possible experience by matching the process to how individual handles their emotions. At the point of making this claim, my research has not discovered anyone offering any type of legal services or conflict resolution services that measure and utilize EQ in their dispute resolution services. Emotional Intelligence (EQ) Our unique process of leveraging understanding via Emotional Intelligence (EQ) both marginalizes and removes the emotions from the dispute resolution process. This will include a mixture of our unique algorithm (contained within) and leverage a variety of technology components to measure emotions including voice analytics, but the core of our proprietary algorithm primarily driven and leveraging the Emotional Intelligence leading technology EQ-i 2.0®.
l. Electronic Facilitated Negotiation Process (FNP), described throughout this document, nobody has ever really heard of electronic negotiation or is asking for this service. In fact, people know what negotiation is overall, the average consumer would think electronic negotiation is just negotiating on the phone, or video chat or any electronic means. Not us! We are introducing an entirely unique way to resolve conflicts without attorneys, courts, mediation, or arbitration. We are blending both AI technology and our entirely unique blend of human elements to deliver the capability or platform for electronic negotiation but the real power, not previously discovered, is to use our facilitated electronic negotiation as an entirely new way to resolve conflicts and thus sun setting the need to use litigation, mediation or arbitration all the processes and tools of the traditional legal system. Our technology empowers and enables disputing parties to resolve THEIR OWN conflicts by assisting us with e.Resolv. Again, this invention is claiming FNP as entirely unique and blending the right mix Human Elements, EQ, AI and our uniquely trained staff is one of this inventions, most important claims.
m. Advanced Emulation of the manual processes of Mediation Private Caucus routines, one of the challenges we have witnessed since Covid-19 and the legal, mediation and arbitration professionals trying to use video conferencing tools like Zoom, how they manage the private caucus process. People trained and who are certified mediators know the importance of private caucuses to the methodology or mediation. In face-to-face mediation, normally with the Mediation practitioner calls for a private caucus (absolutely vital) to the mediation process, the other party goes to a break room, or leaves and it comes back. Even those technology savvy Mediation practitioners that have perfected using Zoom and using the technology creates an electronic video conferencing waiting room, this party is left sitting and waiting and waiting to the mediator to call the back or bring them back in electronic mediation. We don't allow for idle time, in fact if the conflict is highly contentious, we can even bring in another one of our trained staff (who has complete access to all online history of the case as an additional neutral to help the other party understand the remaining obstacles of the conflict and keeping them from reaching settlement. This invention is entirely unique, because during the time the waiting party is waiting, he/she can access the system to review settlement statement and interact with our AI driven, Justine the AI Robot the parties list their Absolute Needs and Desires, and the system can look for deltas and overlaps and then compare similar conflict settlements then match to the needs and desires of the parties. It can make intelligent recommendations for settlement in a process that is automated and can offer a service unlike if the parties were using attorneys or even a neutral mediator. It's Intelligence and Resultative Electronic Negotiation is unlike what could be offered by humans.
n. Human Element(s), specially designed process for next steps, if an impasse is reached, or both parties desire help, you can access Human Professionals via a click, for: 1. Attorneys 2. Negotiation Specialists 3. Professional Facilitators/Case Manager 4. Other Professionals. This would include our own model and training program designed to train subcontractors with our methodology to service clients/customers with a unique mixture of technology and human elements. We do not plan to use human elements, attorneys, mediators or arbitrators. Our training program will develop our planned use of subcontractors. This is unique to any other way conflict resolution is performed in the industry today. Case Manager/Advocate can recommend to the parties to use other professionals. The other professionals, when engaged, can log onto the platform, and see absolutely all that has happened thus far, and especially focus only on the elements that are unresolved and then offer their services to reach a settlement. This is completely original. For example, in divorces or conflicts with financial aspects, attorneys, mediators or arbitrators are not financial advisory professionals. So, parties could agree on a settlement including the financial aspects of the settlement based on desires or emotional aspects. However, the settlements' financial terms may or may not be affordable or maintainable post settlement. As a second example, it is estimated about 90% of conflict is emotionally centered. Our proprietary processes and system were designed, at the core, to leverage the Emotional Intelligence (EQ) processes to greatly reduce the emotions between the parties. In some instances, there could be a need to bring in additional professionals like family counselors or therapists to help either one individual party or both to further reduce the emotions. Our Human Factors. See Diagram 4 at the center bottom to see how we uniquely blend technology and human factors along with our technology partners unlike anything in the market today.
p. Propriety Case Management, one of the most unique elements of our platform and processes, which is offered only when the technology alone is not able to resolve the conflict, this is when our IMPASSE mode is offered and the Case Manager (which is assigned from step one of our process) and he/she who will be especially trained (see #12) and can interact with a very informed fashion (beyond anything the scope of services of a traditional attorney/ADR professional) can offer leveraging traditional service approaches. The impasse process is when various human elements recommended by our specially trained Case Managers, thus if impasse is declared by either both parties or our Case Managers, we can then automatically move the parties to other services offered by our parent company, Cognitive Resolution Solutions (CRSC) which offers either traditional mediation or arbitration, still mostly online (could be face-to-face) of our case managers feel it might help. But the parties will mostly get human contact and less direct technology. Additionally, and uniquely, CRSC offers what we refer to internally as either Traditional Mediator or “Old-School” Mediation and this means, the neutral (mediator or arbitrator) only works with the dispute parties and NO ATTORNEYS allowed on either side. It has already been proven this former approach to ADR, before the ADR industry was hijacked by the legal industry and we strongly feel based on thousands of case experience by our team and our company, adding attorneys to the mediation or dispute resolution process worsened the effectiveness of mediation, arbitration and traditional dispute resolution.
r. Unique Training Program, we will offer a special designed training program for all humans offering their services on our platform and it will enable professionals like attorneys, ADR, Negotiators, Financial Advisors and Psychologists to offer their traditional services. In a blended process which is enhanced by technology to make it easier and less expensive than traditional services available from an individual professional offering their services. We plan to heavily rely on graduates with master's degrees, Master Certificates and Doctorates in Conflict Resolution as Case Managers/Advocates. We contend that graduates of these programs offered by over 120 universities in this country are better trained in all disciplines of conflict resolution than a traditional law school graduate. Our training program will complement the traditional education, and their abilities will be enhanced by using our technology unlike what they can do without our technology. However, the entirely unique part of our training, is that we train our people (we refer to as Human Elements) unlike any other training program available today. It is a 40-hour course that primarily focuses on blending the following disciplines and best practices of traditional negotiation, facilitation of conflict resolution, emotion intelligence in conflict, and blending in traditional Alternative Dispute Resolution processes of mediation and arbitration. Our proprietary training program was developed to reach non-legal professionals but rely on mature and retired people leveraging a subcontractor model. Our special training resources will assist our clients/users in technology, negotiation, facilitation and advisory to resolve their disputes using our propriety processes and systems. Due to our unique training program, our Staffing Model, one of the more unique factors is the type of resources we plan to leverage as subcontractors much like the contractor model of an Uber Driver. We plan to train our other resources with an inhouse training program that blends on training our resources on the technology elements of our Dispute Resolution Platform, Discipline of Facilitation, Mediation-General Practices of ADR, Emotional Intelligence and Best-Practices of Negotiation. Our model will train not only people with legal training but also those mediation trained or certified. We are going to train our people to be uniquely focused on delivering true empathy in negotiation and successful settlement with the goal being both sides of a conflicts feel that after leveraging our platform, they have a WIN-WIN experience.
t. e.Resolv System, should our technology and process methodology does not result in a mutual agreement, we have other options. If our customers/users cannot get beyond an impasse our process again assisted by our Human Element (Facilitator/Case Managers) can opt to either enlist other dispute professionals to find resolution. However, if our Facilitators/Case Managers assisted by the technology, determine we have reached a hard impasse, and we cannot help, we can then route the clients to our other platform, Resolve.Site. This is a further attempt to resolve the case mostly using either mediation or arbitration yet still online by mostly a human-to-human manual process. Additionally, since we are customer satisfaction driven services, if our people and technology can't get this matter resolved, we can refer our clients to our other Human assisted systems to be assisted by Professional Mediators or Arbitrators, or of course the customer can opt out and return to litigation to resolve this conflict.
u. Partner Blend, today as part of this Patent Application we have four (4) primary partners: 1. Google (Cloud Services, AI, Video Conference and other technologies) 2. Lexus/Nexus (repository of active and settled lawsuits of all types and sizes) 3. EQ-I 2.0 (Emotional Intelligence Assessment Service Provider) 4. Chat GPT-4 for Lawyers (AI Services tailored for the Legal Community. Based on our existing Patent Research, we are claiming to be the only invention that uses EQ measures and determinations based on the results of the assessments to factor into the overall dispute resolution process. We are also claiming a unique blend of data and services that are leveraged by our algorithms to deliver this entirely new way to resolve conflicts with the two primary differentiators of Emotional Intelligence and Like/Similar Settlements to enhance the experience of the disputing parties using our facilitated negotiation process.

It should be noted in this application, our technology is based on Google Corporation, Google Cloud Platform and this patent is going to highly leverage key technologies from the Alphabet/Google Corporation and especially Artificial Intelligence, Video Conferencing, Office Capabilities of both Google Docs™ and Microsoft Office™, Components and Security. We recognize in our Patent Application it cannot include any of the aspects of the patented Google technologies, but we wanted to note we chose the Google Could Platform (GCP) because we felt it was best for all aspects of our requested Patented Platform.

### FIG. 5: Our Primary Algorithm

### This Invention has Eight (8) Main Components:

1. Intake/Onboarding Communicator—This component is responsible for communicating with the parties that are involved or engaged with the “system.” It will interact with each “party” to collect the required information for establishing the details of the “party” itself and the details of the dispute service that is needed by the “parties”. These details include but are not limited by the following:
   a. Basic minimum “party” information like name, address, cell number, email address, and other demographic information like age, race, gender, geographic location, etc.
   b. Emotional Intelligence (EQ) information for determining the psychological profile of each “party.”
   c. Intake Funnel information about how the I/O Comm unit was initially engaged; this could be social media marketing, or from the court system, or from a Virtual Assistant, or from another software platform.
   d. Dispute category and all the information that will need to be determined based on category.
2. e.Resolv—This component is responsible for the “Resultative Dispute Document” that is the main final product of the dispute engagement initiated by the “parties.” A unique aspect of e.Resolv is that it immediately or as soon as possible offers each party a quick solution and asks for a settlement. e.Resolv is the component that determines how the “system” will process the dispute. It is responsible for the following,
   a. If the dispute will result in a simple solution like a certain dollar amount to be paid, or a number of items to be distributed, or a simple statement to be made, etc. or if the solution is more complex and will require more system resources to e.Resolv
   b. Discovery of all the inputs to the dispute
   c. All the possible outcomes including BATNA or others.
   d. Desire for an “immediate” resolve or solution
   e. Begins the construction of the resolution document as soon as possible and begins to provide to each party the makings of the solution or resolution.
f. Settlement costs analysis so that each party begins to understand the “costs” associated with further negotiations especially when or if a human element is engaged in the process.
   g. Impasse avoidance so that we get to a settlement with the least amount of costly friction.
3. e.DNA—This component is the heart, meat, and soul of the system. e.DNA is fed by e.Resolv and feeds to e.Resolv. e.DNA is also fed by other data objects within the system like the Customer Database, the Conflict Types or Dispute Types Database, the Resolutions Database, the Advisory Inputs Database, and the Sample or Example Solutions Database. There will be other data objects that the e.DNA component will feed from and feed to including well established data stores like Lexus/Nexus, Emotional Intelligence (EQ) data stores, and Artificial Intelligence (AI) data stores, etc.
4. Virtual Assistant (“Hey TeDR or Hey Justine”)—This component is a virtual assistant much like Siri, or Alexa, or Google that will be implemented on these same networks. When a user wants to ask the most informed chat bot on the network questions about dealing with disputes and dispute resolutions the user can simply say “Hey TeDR, I'm thinking about getting a divorce can you help me?” TeDR will use its vast knowledge to help point the user in the right direction. TeDR will communicate with e.DNA using the minimum amount of user knowledge to help the user analyze the question. This component requires more detail. Our AI Robot, Justine is the heart of this capability
5. Human Factors—This component represents the human element that may be required in a negotiation or dispute/conflict resolution or simply in using the system. The goal of the system is to use its knowledgebase to create the Resultive Dispute Document without any human intervention. At some point, some negotiations will require a human factor. This human factor will be implemented using,
   a. Customer Support AI bot for helping the “party” understand the inputs that are being requested or to help the “party” understand how the system works, etc.
   b. Technical Support AI bot for helping the “party” with system problems that may come up because of technical computer issues.
   c. Negotiator AI bot for helping the “party” consider various aspects of the process.
   d. Professional Advisor AI bot for helping the “party” in case there are subject matter issues for example tax implications, or financial planning implications, etc.
   e. Our unique Human Factors training and delivery model to deliver true inspired Technology-enhanced Dispute Resolution.
6. Integration APIs—This is the “Black Box” component that will allow every kind of external system to connect to and integrate with the “system”. This will be a “well defined” interface that will evolve over time. It will be based on industry standards like R.E.S.T. and will, over time, create a standard for automated dispute resolution integration. It will be developed using the TeDR standards as well as other industry standards as they evolve.
7. Justine our AI Robot Assistant—We developed Justine to represent our “AI” Driven Dispute Resolution Assistant. Justine begins as part of our Conflict Resolution game, where prospective user/clients can play our proprietary computer game to demonstrate our simple and unique our technology is to use. The game is a points accumulation game where users have six unique simulations of standard common conflicts. Additionally, Justine is the “HELP” element of our technology platform, and she can be called upon for support while using the system.

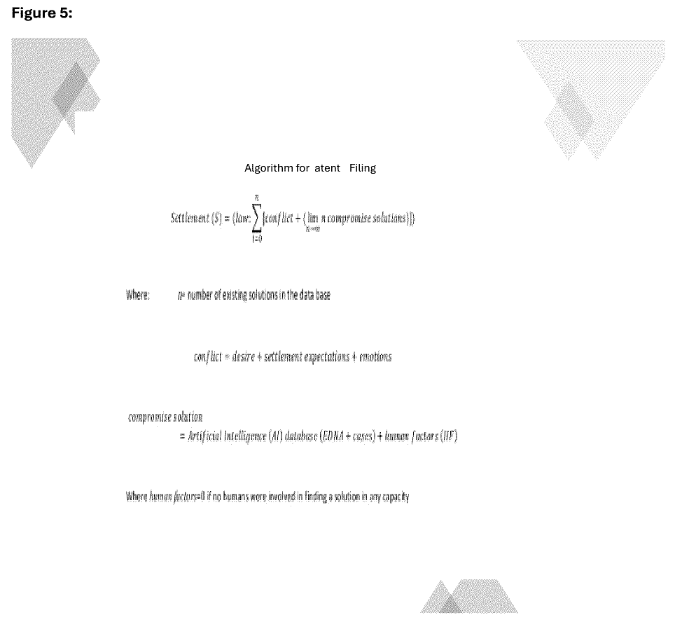

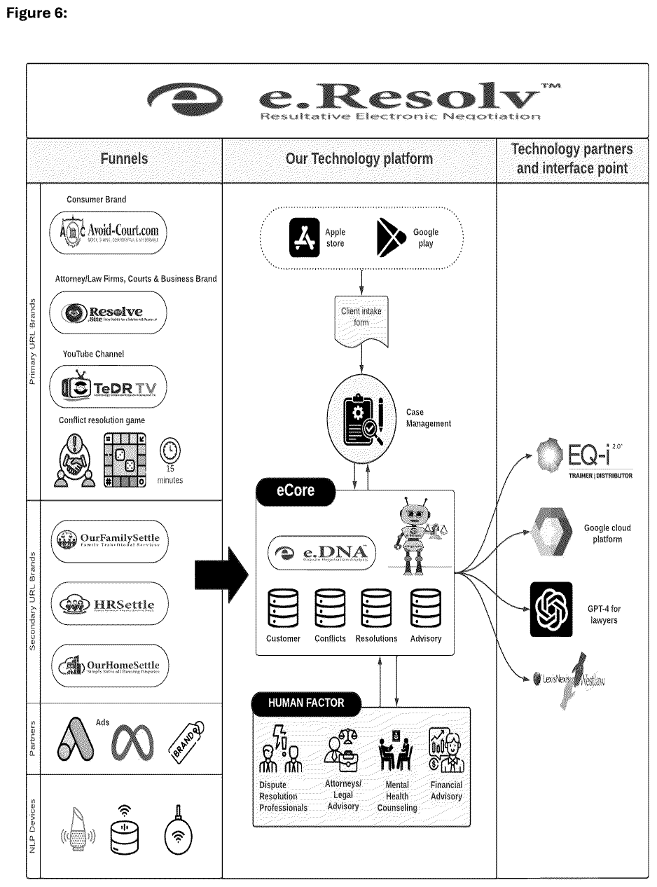

In conclusion, FIG. 4 is a graphical representation of the e.Resolv Platform as described in detail above in the Patent description. FIG. 4 displays the heart of the FUNNEL layer, we refer to the Funnel Layer as funnel feeders that are feedback Google Search, Go. e PDA Devices (Okay Google) and Alexa. The goal is the human natural language interface using questions like: How do I resolve “Specific Conflict” type and have these PDA searches recommend, Avoid-Court and point the user to the either the Google Store or Apple Store for OUR Applet. The other primary FUNNELS will be Google Ad words and the Meta Corporation Ad Manager, using an animated video ad, describing how Avoid-Court works and pushing potential users to our INTAKE process again via the applet or website to hopefully open a case.

We are also going to concurrently as the Patent describes launch a Conflict Resolution and Electronic Negotiation Computer Game to help users understand how to use our platform and users can play the game and accumulate points for successful negotiations against the platform engine. We plan to award the top points winner to attend the Harvard Negotiation Project Certificate Programs along with the Founder of Cognitive Resolution Solutions Corporation, David W. Puckett and both he and the winner will attend the Harvard Program and earn a certificate. Lastly, we are going to offer 15 minutes for FREE use of the platform to try the system before Opening a Case and entering your credit card to open a case officially. If the users can resolve their conflict within the 15-minutes, there will be NO CHARGE. This approach is expected to drive consumers to try our technology and demonstrate our simple and low cost our services are to resolve conflict. It also needs to be noted, even if the parties are already in active litigation and both parties are represented by attorneys, they can use our system to attempt to resolve their conflicts without losing their position in the docket of active litigation.

As the Patent Description outlines, our Intake and Case Manager (first and most important Human Element) our customers will encounter. As noted above, our Technology-enhanced Dispute Resolution (TeDR) methodology White Paper updated at least semi-annual it was first introduced to the market as our contribution as a public-domain methodology for resolving conflicts. Today, we are making it the primary asset of our Non-Profit Academic Think-Tank to promote best practices and technology standards for the industry known as Online Dispute Resolution. is the basis for this new system that is currently in final stage of architecture and developments starts in the fourth quarter 2024.

### FIG. 6: This Final Diagram Displays Workflow, Marketing Funnel Feeds and Our Technology Partners Which All Make Our Invention and Patent Claim Entirely Unique

### CONCLUSION

This concludes our Non-Provisional Patent Application dated Sep. 11, 2024. We look forward to providing any required clarification or in formal defense of any challenges presented to us by the United States Patent office. We plan to launch the Mobility Applets and our e.Resolve and e.DNA Dispute Resolution platform in the 1^{st} quarter 2025. We are actively negotiating with potential partners and including potential international parties (currently initially focused on Latin American (LATAM) including the two language versions of Spanish and Portuguese. Additionally, we will launch in the 1^{st} quarter 2025 a social media market campaign to build awareness of our platform. We are also actively soliciting “White Label” branding partners who desire to leverage our e.Resolv and e.DNA platform as the Dispute Resolution engine for their individual brands domestically and internationally. We are positioning our technology as the single engine to be leveraged as a Transactional Engine in exchange for a transactional fee.

We claim this is unique in the legal and dispute resolution industry. Our goal is for our primary consumer brand, Avoid-Court.com will be our primary funnel (see FIG. 4, left side) and expecting our overall financial success will not be our brand(s), but to establish ourselves all the preferred and market leading Dispute Resolution Platform, and revenue coming from nominal transaction fees.

What is claimed is:

1. A method for facilitating conflict resolution between users, the method comprising:
receiving, using a communication device, an emotional behavior response of at least one user;
receiving, using the communication device, one or more conflicts;
receiving, using the communication device, governing law applicable to the one or more conflicts;
analyzing, using a processing device, the one or more conflicts using a machine learning algorithm, wherein the machine learning algorithm is configured for:
identifying governing law being violated based on the receiving of the or more conflicts; and
monitoring the emotional behavior response of the at least one user;
generating, using the processing device, a conflict resolution based on the analyzing of the one or more conflicts; and
transmitting, using the communication device, the conflict resolution to the one or more users.
